(19) United States
(12) Patent Application Publication
(10) Pub. No.: US 2026/0098780 A1
(43) Pub. Date: Apr. 9, 2026

(54) AUTOMATED VAPOR GENERATING MACHINE

(71) Applicant: PROFLEX+ DISTRIBUTION INC., Point Claire (CA)

(72) Inventor: Jeffrey Lerman, Pincourt (CA)

(21) Appl. No.: 19/204,149

(22) Filed: May 9, 2025

Related U.S. Application Data
(63) Continuation of application No. PCT/CA2023/051494, filed on Nov. 9, 2023.
(60) Provisional application No. 63/382,973, filed on Nov. 9, 2022.

(51) Int. Cl. G01M 3/28

(52) U.S. Cl. CPC G01M 3/28

(57) ABSTRACT

Provided is an automatic vapor generating machine for leak size estimation in a fluid system of a vehicle. The machine is configured for connecting to a source of pressurized gas. The machine generates vapor by heating a liquid in a vapor generating chamber that is thereafter conveyed into the fluid system. A controller controls the operation of the machine, including controlling an electrically controllable valve, a flow sensor, a pressure sensor, a heating switch and a display that is mounted on the machine. The controller has a processor and a memory that are programmed to execute instructions to run multiple leak test programs, collect and process data from the sensors, estimate leak sizes in the fluid system and display graphical representations of the test results on the display. The graphical representation allows the operator to analyze graphs and other data displayed on the display. A method therefor is also disclosed.

This patent application is a continuation patent application of PCT/CA 2023/051494 filed on Nov. 9, 2023, designating the United States, that claims priority of U.S. provisional patent application 63/382,973 filed Nov. 9, 2022, the contents of which are hereby incorporated by reference.

### FIELD OF THE TECHNOLOGY

The present technology relates generally to the field of vapor generating devices used to test the integrity of a fluid system of a vehicle, and, more specifically, to a vapor generating device characterized having a controller that is capable of performing leak tests on the fluid system.

### BACKGROUND

Systems that contain and operate by using a fluid, such as gas, liquid or a combination thereof are used widely throughout the many industries. Various vehicles like cars, trucks, motorcycles have various fluid systems including the fuel system, the exhaust system, the heating, cooling and ventilation (HVAC) system, and the hydraulic power steering and brake systems. Many industrial machines and other devices also use fluid systems therein to operate. Exemplary fluids in such systems include air, fuel, hydraulic fluids, manufactured gases, and other liquids. Typically, fluid systems must be properly sealed to prevent leakage of the system operating liquid from the fluid system. In cases when leaks in the fluid systems occur due to damages, wear and tear, or regular usage, such leaks must be detected and repaired sealed.

Engineers employ various methods and devices to detect leaks in such as fluid systems as described above. In the automotive industry, engineers often use vapor generating apparatuses or devices that can generating a visible gas or a vapor that is mixed with air to detect leaks in fluid systems of vehicles. Such devices are commonly referred to as smoke machines, where the term “smoke” is refers to a non-toxic aerosol mist produced by evaporation and condensation at controlled temperatures. For example, the use of smoke generating machines to detect leaks in internal combustion engine systems are well known in the art. More specifically, such leak detection systems are extensively used in engine diagnostic and maintenance procedures, and in particular can be used to find leaks in EVAP systems, valves, gaskets, hoses, vacuum lines and reservoirs, throttle bodies, EGR valves, air intake ducting, intake manifolds, and exhaust systems among others.

In the context of the following description, the terms “smoke” and “vapor” are used interchangeably and refer to either any solution (e.g., petroleum-based) that upon heating becomes airborne as a visible aerosol mist, spray, gas, vapor or any combination thereof.

As is well known in the art, operating smoke generating machines to detect leaks in vehicles requires the following steps: mechanics connect the smoke generating machines to an external source of pressurized gas, typically air or any inert gas, connect the output hose of the smoke generating machine to a fluid system of a vehicle that requires leak testing, turn on the smoke generating machine and pump a pressurized mixture of air/inert gas and smoke/vapor into the fluid system of the vehicle. By observing any visible smoke/vapor that exits a small and often visually imperceptible hole in the fluid system under test, the mechanics are able identify any leaks that need to be addressed in the fluid system under testing.

For example, U.S. Pat. No. 10,393,612 teaches a smoke generating machine that generates visible gas via the process of vaporization, evaporation and/or condensation and delivers under pressure into a fluid system to be tested. This machine is a great piece of equipment, however, it does not any automated controls, thus requiring all tests thereon to be ran manually.

In the example of U.S. Pat. No. 8,737,826 entitled HIGH PRESSURE SMOKE MACHINE, there is described a smoke machine that can produce a controlled vapor at a test pressure of up to and exceeding 30 psi, for safe usage for leak determination and location in internal combustion engines with forced induction systems. This machine albeit being very useful for its purposes does not have any automated functions that may make this machine more user friendly.

In other examples, such as in those listed for sale on the website www.ebay.com, various smoke generating machines, such as the “Ancel EVAP Smoke Machine Leak Detector Car Fuel Pipe System Leakage Diagnostic Tester”, the “Romondes SM 603 Automotive Smoke Machine, Leak Detector, EVAP Vacuum Leak Tester” and the like show devices that are specifically catered to the automotive industry and are aimed at leak testing fluid systems in vehicles. These machines also lack any automation that may facilitate their use. Also these machines use analog pressure gages to determine the pressure inside the smoke generating machine and analog flow meters to determine a presence of gas flow within the smoke generating machine, which requires the mechanic to constantly observe the dials on these machines to determine if there's change of pressure or a change in flow in the smoke machine, which may be indicative or a change of pressure or flow in the fluid system that is being tested. This setback often requires two people to operate such machines, where one person will look at the dials and the other person will look for a leak in the system by trying to find a hole in the fluid system of the vehicle that is letting the smoke/vapor therethrough.

Furthermore, different types of fluid systems clearly have different inspection pressure requirements. As such, a vapor generating devices designed to operate at a specific test pressure is only useful for leak detection in the fluid systems that match the respective inspection pressure requirements, i.e. that are within a tolerance of the specific test pressure of the fluids system. For example, a smoke machine designed to produce vapor at the standard test pressure of 0.471 psi can be used for leak detection and location in a naturally aspirated internal combustion engine, but likely would not be efficient in a boosted, forced induction engine. Similarly, a smoke machine designed to produce vapor at a test pressure of 30 psi can be used for leak detection and location in a forced induction engine, but not in a naturally aspirated internal combustion engine, since the excessive test pressure would damage the engine systems that are designed to contain a much lower pressure (e.g. 1 psi).

In the auto mechanic industry, or other such similar industrial/commercial vehicle service industry, it expensive and inefficient to stock multiple different smoke generating machines in order to be able to perform leak detection and location on different fluid systems having different inspection (test) pressure requirements. It is also expensive and inefficient to employ two people on a job of leak detection of a fluid system of a single vehicle. In cases when two people are not available, a single mechanic may not be able to use a smoke generating machine to detect all leaks effectively every time, due to the lack of automation in the smoke machines and due to the need by the mechanic to observe two separate measurements: the pressure values and flow meter values in real-time on the dials of existing machines, which may be a cause for diagnostic error by the mechanic.

The devices heretofore suffer from a number of disadvantages, which include the lack of satisfactory automation, insufficient precision of determining the pressure and the gas flow of the vapor generating machines during leak testing. Additionally, those devices may require additional manipulations to be performed by an operator of the smoke machines that may make the auto mechanic services to be more time consuming, thus increase the overall cost-per-hour of providing such services to their clients.

What is needed is a vapor generating machine for the auto mechanic and other vehicle service industries, as well as a method of use thereof, which solve one or more of the problems described herein and/or one or more problems that may come to the attention of one skilled in the art upon becoming familiar with this specification.

The objective of the present technology is to provide a more efficient and less time-consuming method of operating a vapor generating machine for detecting leaks in fluid systems in vehicles. The vapor generating machine should be safer, more reliable, easily installable and more time-effective during the using thereof, than the conventional smoke generating machines.

### SUMMARY

It is thus an object of the present technology to ameliorate at least some of the inconveniences present in the prior art.

The present invention relates to providing an intelligent vapor generating machine that may be able to run various types of leak tests multiples times until the presence or an absence of a leak is determined and, in case of a leak presence, its size is estimated. The vapor generating machine should be adaptable to be used to test various types of fluid systems of vehicles including, but not limited to, car, trucks, motorcycles, heavy machinery and the like.

Embodiments of the present technology have been developed based on engineers' appreciation of at least one technical problem associated with the prior art approaches to determining leaks in fluid systems of vehicles and to estimating sizes thereof.

More specifically, the presently known prior art methods and machines do not appear to take into account the need for calibrating various vapor generating machines with specific fluid systems of vehicles, thus allowing for an accumulation of micro-errors in measurements that may lead to providing operators of these machines an overall misleading result.

The engineers further discovered that it would be beneficial to provide an automated vapor generating machine for leak detection that will be able to automatically run a required number of leak tests to measure over the duration of several leak tests electronic signals provided by sensors installed in the vapor generating machine, process the measured data using computer assisted estimation and analysis that generate reliable results that may be used to estimate a leak size in a tested fluid system, and that may be used to generate usable graphs that may be used by the operator to draw conclusions on the state of the fluid system being tested, the number and size of leaks and possible required repairs.

According to a first broad aspect of the present technology, there is provided an automatic vapor generating machine for leak size estimation in a fluid system of a vehicle. The machine has a housing and a vapor generation chamber located inside the housing. The vapor generating chamber has a liquid reservoir for holding a supply of liquid and a heating element disposed within the chamber for vaporizing the liquid. The housing has a gas inlet for connection to a source of pressurized gas. The gas inlet extends from the vapor generating chamber and though the housing to the outside of the machine where a hose to the external source of gas may be connected. An electrically controllable valve connects the gas inlet to the vapor generation chamber such that once the valve is actuated, a gas flow may be effected from via the gas inlet into the chamber. An outlet conduit is in fluid communication with the chamber and extends from the chamber to the outside of the housing. The outlet conduit is configured to convey the vapor/smoke from the chamber into the fluid system that is being tested or to convey a gas from the chamber the fluid system. An at least one flow sensor is in fluid connection with the chamber. An at least one pressure sensor is in fluid connection with the chamber. In some embodiments the machine may have only a pressure sensor, in other embodiments, the machine may have only the flow sensor, and in other embodiments, the machine may have both a pressure sensor and a flow sensor. Either of the flow or the pressure sensors may be positioned proximate of gas inlet or may be positioned proximate the outlet conduit or may be positioned anywhere inside the chamber. The flow sensor measures the flow measurements in the chamber and the pressure sensor measures the pressure in the chamber. The sensors generate electronic signals that are received by a controller. The machine also has a heating switch for controlling the heating element. A display is mounted to the housing. The controller is connected to the electrically controllable valve, to the at least one flow sensor, to the at least one pressure sensor, to the heating switch and to the display. The controller has a memory and a data processor. The data processor is able to execute instructions stored in the memory of the controller. The instructions include any of the following steps (no particular order is given thereto): a step of receiving an operator's command to perform a leak test, a step of opening the electrically controllable valve to cause one of the vapor or the gas to flow through the outlet conduit to attempt to pressurize the fluid system of the vehicle connected to the outlet conduit, a step of closing the electrically controllable valve after a predetermined period of time, the step of recording in the memory a series of values of the electronic signal over a duration of the leak test, the step of generating a graphical representation of the series of values of the electronic signal over the duration of the leak test and present the graphical representation on the display. The graphical representation illustrates at least one flow measurement over time estimating a leak flow rate, or at least one the pressure measurements in the chamber over time showing a leak dependent pressure decay over time, or both the flow measurement over time estimating a leak flow rate and the pressure measurements in the chamber over time showing a leak dependent pressure decay over time. The graphical representations illustrate measurements measured over a duration of a leak test or a series of leak tests.

In one aspect of the invention, the automatic vapor generating machine further includes a pressure regulator positioned proximate the gas inlet and is used for controlling the pressure in the chamber. The pressure regulator is connected to the controller and is controllable by the controller.

In a further aspect of the invention, the controller is configured to estimate a leak size over the duration of the leak test.

In another aspect of the invention, the information about the leak size may be displayed on the display, or it may be displayed on an LED leak size indicator positioned on the housing and connected to the controller, or both. The LED leak size indicator consists of a set of LED lights, or any other type of lights configured to selectively indicate a first leak size and a second leak size.

In one aspect of the invention, an automatic vapor generating machine as defined in claim 1, wherein the controller further includes a wireless connection configured to transmit data to a secondary device via a wireless network.

In a further aspect of the invention, an automatic vapor generating machine as defined in claim 1, further including and temperature sensor in the chamber, the temperature sensor being connected to the controller and configured to send a temperature measurement electric signal thereto.

In another aspect of the invention, the controller is configured to store and analyze historical data received from any one of the flow sensor, the pressure sensor and the temperature sensor. The controller center is configured to generate at least one graphical representation on the display. The at least one graphical representation is indicative of one of a time of occurrence of a leak, a pressure difference registered by the machine as a result of the leak, a first data for calculating pressure average, a second data for calculating flow measurement average, a third data for comparing tests, and an indication to run additional tests.

In one aspect of the invention, the controller is configured to receive at least an input selection of one of a language of operation, an operating pressure in psi, Bar or KPa, a manual mode of operation, an automatic mode of operation, a test time, a vapor output, an air output, an alternating vapor and air output, a multiple operating program mode. The display is configured to display at least an information related to any one of the language of operation, the operating pressure in psi, Bar or KPa, the manual mode of operation, the automatic mode of operation, the test time, the vapor output, the air output, the alternating vapor and air output, the multiple operating program mode.

In a further aspect of the invention, the controller is configured to provide one of an audio and a visual indication of one of a low fuel, machine overheating, leak occurrence, pressure drop, and a machine mal-functionality.

In another aspect of the invention, the processor is able to execute instructions stored in the memory for operating the heating switch to cause the heating element to heat the liquid, thereby generating the vapor in the chamber for performing the leak test with vapor.

In one aspect of the invention, the processor is able to execute instructions stored in the memory for processing a series of values of the electronic signal over the duration of the leak test to calculate at least one of a time of occurrence of a leak, a pressure difference registered by the machine as a result of the leak, a pressure average over the duration of the leak test, a flow measurement average over the duration of the leak test, a pressure decay as a function of time over the duration of the leak test, changes in flow over time over the duration of the leak test, and a comparison of one of results and measurements of at least two leak tests.

In a further aspect of the invention, the at least one of a flow sensor and a pressure sensor are located proximate to one of the gas inlet and the outlet conduit.

According to a second broad aspect of the present technology, provided is an automatic vapor generating machine for leak size estimation in a fluid system of a vehicle. The machine includes a housing, a vapor generating chamber that has a liquid reservoir adapted for holding a supply of a liquid, as well as a heating element that is disposed within the chamber, and the heating element is for vaporizing the liquid. The machine also has a gas inlet in the housing for connecting the machine to the source of pressurized gas. The pressurized gas supplied to the machine is controlled via an electrically controllable valve. This valve controllably connects the gas inlet to the vapor generation chamber. To deliver the gas or a mixture of gas and vapor from the machine to a fluid system for testing an outlet conduit is designed as part of the machine. The outlet conduit is in fluid communication with the chamber, and it is configured to convey one of a vapor or a gas from the chamber. In some examples, a hose would be connected to the outlet conduit to further convey the gas or the vapor with gas to the fluid system of a vehicle, in other examples, the outlet conduit includes of a hose, a flexible tube, a pipe or the like to deliver the convey the gas or the vapor with gas to the fluid system of a vehicle from the chamber. The machine has an at least one a flow sensor and at least one pressure sensor. The flow sensor is in fluid connection with the chamber. It is understood that the fluid sensor may be positioned proximate the gas inlet, the outlet conduit, within the chamber or otherwise connected to the chamber in order to take flow measurements of the gas or vapor flowing from the chamber to the fluid system that is being tested. The pressure sensor is in fluid connection with the chamber. It is understood that the pressure sensor may be positioned proximate the gas inlet, the outlet conduit, within the chamber or otherwise connected to the chamber in order to measure pressure of the gas or vapor in the chamber. Each of the flow and the pressure sensors are configured to generate electronic signals that represent the measurements of flow or pressure and that are transmitted to a controller. The machine also has a heating switch for controlling the heating element. The machine also has a display mounted to the housing. The machine also has a controller. The controller is connected to the electrically controllable valve, to the at least one of the flow sensor and the pressure sensor, to the heating switch and to the display. The controller has a memory and a data processor. The processor is able to execute at least two leak test programs stored in the memory for controlling the machine. The at least two leak test programs are able to execute commands. These commands allow to perform at least three pressure tests, wherein each pressure test includes opening and closing the electrically controllable valve to provide a gas flow to pressurize the chamber and the fluid system to a predetermined pressure at least once during test. These commands allow to receive and analyze the at least one electronic signal to estimate a leak size of the fluid system of the vehicle during each test. The at least two leak test programs include at least one of a vapor test and a gas test. During the vapor test, the controller actuates the heating element, and the machine generates vapor, and during the gas test, the machine pressurizes the chamber and the fluid system of a vehicle with the gas from the source of the pressurized gas without generating vapor. The at least two leak test programs of the controller are manually actuated by an operator of the machine. The display is configured to display a selection of the at least two programs, initial parameters for any one of the at least two leak test programs, one of a real-time processed data from any one of the flow sensor and the pressure sensor, and a historical processed data from any one of the flow sensor and the pressure sensor. The data displayed on the display upon operating one of the at least two leak test programs provide an estimation of the leak size.

In one aspect of the invention, a pressure regulator is located proximate the gas inlet for controlling the pressure in the chamber of the supplied gas from the source of pressurized gas. The pressure regulator is connected to the controller in such a manner that is controllable by the controller.

In another aspect of the invention, the controller is configured to calculate one of a pressure average, a flow average, a pressure decay function and a differential pressure decay.

In another aspect of the invention, the automatic vapor generating machine includes an LED leak size indicator positioned on the housing and operationally connected to the controller. The LED leak size indicator is a set of LED lights configured to selectively indicate one of a first leak size and a second leak size.

In another aspect of the invention, the predetermined pressure of any one of the at least two leak test programs is within a range of 0.5 to 2.5 psi or is within a range of 5 to 15 psi.

In another aspect of the invention, the display is an LCD screen. It is understood that the display may be any type of suitable screen that may be electronically connected to the controller and that has sufficient dimensions to fit onto the housing and sufficient resolution to display the graphical representations intended to be displayed by the machine controller during the operation of the machine.

In another aspect of the invention, the automatic vapor generating machine also has a temperature sensor that is position within the chamber. The temperature sensor is connected to the controller and is configured to send temperature measurement electric signals to the controller.

In another aspect of the invention, the controller is configured to store and analyze historical data received from any one of the flow sensor, and the pressure sensor, and the controller is configured to generate at least one graphical representation on the display, the at least one graphical representation being indicative of one of a time of occurrence of a leak, a pressure difference registered by the machine as a result of the leak, a first data for calculating averages, a second data for calculating means, a third data for comparing tests, and an indication to run additional tests.

In another aspect of the invention, the controller is configured to provide one of an audio or a visual indication of one of a low fuel, machine overheating, leak occurrence, pressure drop, and a machine mal-functionality.

In another aspect of the invention, the controller is configured to receive an input selection of one of a language of operation, an operating pressure in psi, Bar or KPa, a manual mode of operation, an automatic mode of operation, a test time, a vapor output, an air output, an alternating vapor and air output, a multiple operating program mode.

In another aspect of the invention, the processor is able to execute instructions stored in the memory for operating the heating switch to cause the heating element to heat the liquid thereby generating the vapor in the chamber for performing of the pressure test with vapor.

In another aspect of the invention, the at least one of a flow sensor and a pressure sensor proximate to one of the gas inlet and the outlet conduit.

According to a third broad aspect of the present technology, provided is a method for leak size estimation in a fluid system of a vehicle using an automatic vapor generating machine that is connected to a source of pressurized gas. The method includes the following steps that are described below without any specific order. The step of filling a liquid reservoir for holding a supply of liquid with a vapor generating liquid. The step of powering on the vapor generating machine. The step of selecting a leak test program from a selection on a display mounted on the housing of the vapor generating machine by manually commanding a controller. The step of setting a test pressure for the test program of the vapor generating machine manually commanding the controller. The step of setting a test time manually commanding the controller. The step of having the controller run the leak test program with selected test pressure and test time. The step of reading results of the leak test on the display by an operator, the results including a graphical representation of a pressure decay. The step of observing one of a pressure drop indicated in the graphical representation and a flow measurement of one of a gas or vapor flowing from the chamber into the fluid system of the vehicle. The step of determining at least one of a leak size in the fluid system of the vehicle, a time of occurrence of a leak, a pressure difference registered by the machine as a result of the leak, a first data for calculating a pressure average, a second data for calculating flow measurement average, an indication to run additional tests.

In another aspect of the invention, the display includes one of a smartphone display, a computer display, a tablet display, a television display, a projector display, and any other display configured for displaying data generated by the controller. The technology of this invention is not limited by any specific design of a display. The goal of the display is to display information to a user such that the visual information displayed thereon may be read by the user.

In the context of the present specification, unless specifically provided otherwise, the term “vaporize” generally refers to means to transform a liquid into smoke, while the term “primarily capillary action” (or other similar term) means that the liquid is conveyed by this type of force more than any other force (such as pumping, or pressure differentials caused by suction), but does not exclude that some force may be applied to the liquid by modes other than capillary action.

In the context of the present specification, unless specifically provided otherwise, the terms “first”, “second”, “third”, etc. when they are grammatically used as adjectives, have been used as adjectives only for the purpose of allowing for distinction between the nouns that they modify from one another, and not for the purpose of describing any particular relationship between those nouns. Thus, for example, it should be understood that, the use of the terms “first leak size” or “second leak size” is not intended to imply any particular function, order, type, chronology, hierarchy or ranking (for example) of/between the leak sizes, nor is their use (by itself or in a combination) intended imply that any “first” or “second leak size” must necessarily exist in any given situation. Further, as is discussed herein in other contexts, reference to a “first” element and a “second” element does not preclude the two elements from being the same actual real-world element.

In the context of the present specification, unless specifically provided otherwise, a “controller” is any computer hardware that is capable of running programmable instructions appropriate to the relevant task at hand. The use of the term “a controller” does not preclude multiple controllers being used in receiving/sending, carrying out or causing to be carried out any task or request, or the consequences of any task or request, or steps of any method described herein.

In the present context, the use of the term a “program” is not intended to mean that every task (e.g. received instructions or requests) or any particular task has been received, carried out, or caused to be carried out, by the program; it is intended to mean that any number of instructions and hardware devices may be involved in receiving/sending, carrying out or causing to be carried out any task or request, or the consequences of any task or request.

For the purposes of this application, the terms “user” and “operator” mean a person that uses the invention. The terms “user” and “operator” may also refer to a group of persons that are involved in using the invention, and such a group of persons may include persons operating the machine directly, operating the machine indirectly, assisting in operating the machine, reading graphical representations on the display or other data displayed thereon, without any limitation to the meanings of the terms “user”and “operator”.

In the context of the present specification, unless specifically provided otherwise, the expressions “element”, “part” or “component” is meant to include a physical element (hardware appropriate to a particular context) and electronic signals (including diginal instructions) that is both necessary and sufficient to achieve the specific function(s) being referenced.

Implementations of the present technology each have at least one of the abovementioned object and/or aspects, but do not necessarily have all of them. It should be understood that some aspects of the present technology that have resulted from attempting to attain the abovementioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic front view of an exemplary automatic vapor generating machine implemented in accordance with an embodiment of the present technology;

FIG. 2, is a schematic one side view of an exemplary automatic vapor generating machine implemented in accordance with an embodiment of the present technology;

FIG. 3, is a schematic another side view of an exemplary automatic vapor generating machine implemented in accordance with an embodiment of the present technology;

FIG. 4 is a schematic back view of an exemplary automatic vapor generating machine implemented in accordance with an embodiment of the present technology;

FIG. 5 is a schematic top view of an exemplary automatic vapor generating machine implemented in accordance with an embodiment of the present technology;

FIG. 6 is an exemplary schema depicting a representation of the connection of a source of pressurized gas connected to the chamber of an exemplary automatic vapor generating machine implemented in accordance with an embodiment of the present technology;

FIG. 7 is a schematic representation of the controller of an exemplary automatic vapor generating machine implemented in accordance with an embodiment of the present technology;

FIG. 8 is a schematic representation of an exemplary automatic vapor generating machine implemented in accordance with an embodiment of the present technology;

FIG. 9, there is depicted a block diagram of a method for performing one example of a leak test by the controller implemented in accordance with an embodiment of the present technology;

FIG. 10, there is depicted a block diagram of a method for performing another example of leak test by the controller implemented in accordance with an embodiment of the present technology;

FIG. 11, there is depicted a block diagram of a method for performing yet another example of leak test by the controller implemented in accordance with an embodiment of the present technology;

FIG. 12 is an exemplary graph depicting a representation of flow-based leak test in accordance with an embodiment of the present technology;

FIG. 13 is an exemplary graph depicting a representation of an example of a leak dependent pressure decay over time in accordance with an embodiment of the present technology.

FIG. 14 is an exemplary schematical representation of the graphical information that may be displayed on the display in accordance with an embodiment of the present technology.

FIG. 15 is an exemplary schematical representation of the graphical information that may be displayed on the display and a portion of the housing of the vapor machine in accordance with an embodiment of the present technology.

FIG. 16 is an exemplary schematical representation of the graphical information that may be displayed on the display in accordance with an embodiment of the present technology.

FIG. 17 is an exemplary schematical representation of the graphical information that may be displayed on the display in accordance with an embodiment of the present technology.

FIG. 18 is an exemplary schematical representation of the graphical information that may be displayed on the display in accordance with an embodiment of the present technology.

FIG. 19 is an exemplary schematical representation of the graphical information that may be displayed on the display in accordance with an embodiment of the present technology.

FIG. 20 is an exemplary schematical representation of the graphical information that may be displayed on the display in accordance with an embodiment of the present technology.

FIG. 21 is an exemplary schematical representation of the graphical information that may be displayed on the display in accordance with an embodiment of the present technology.

FIG. 22 is an exemplary schematical representation of the graphical information that may be displayed on the display in accordance with an embodiment of the present technology.

FIG. 23 is an exemplary schematical representation of the graphical information that may be displayed on the display in accordance with an embodiment of the present technology.

FIG. 24 is an exemplary schematical representation of the graphical information that may be displayed on the display in accordance with an embodiment of the present technology.

FIG. 25 is an exemplary schematical representation of the graphical information that may be displayed on the display in accordance with an embodiment of the present technology.

FIG. 26 is an exemplary schematical representation of the graphical information that may be displayed on the display in accordance with an embodiment of the present technology.

### DETAILED DESCRIPTION

Reference will now be made in detail to some specific examples of the embodiments of the invention including some modes of carrying out the invention that are contemplated by the inventors to be suitable for understanding the technology. Examples of the specific embodiments are illustrated in the accompanying drawings. While the technology is described in conjunction with these specific embodiments, it will be understood that it is not intended to limit the invention to the described embodiments. On the contrary, it is intended to cover alternatives, modifications, and equivalents as may be included within the scope of the invention as defined by the appended claims.

For example, the techniques and mechanisms of the present technology may be described in the context of manufacturing and operating any types of automated vapor generating machines. It should be noted that the techniques and mechanisms of the present technology apply to a variety of methods of executing smoke leak test combinations, and not just the method outlined herein. In the following description, specific details are set forth in order to provide a thorough understanding of the present technology. Particular exemplary embodiments of the present technology may be implemented without some or all of these specific details. In other instances, well known process operations have not been described in detail in order not to unnecessarily obscure the present technology.

Various techniques and mechanisms of the present technology will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a method or a machine can use devices connected via a wireless network, such as Bluetooth, WIFI or other wireless technology, multiple processors, multiple memories, cloud computing, distributed ledger technology, video cards or graphic accelerators, or any combination thereof, while remaining within the scope of the present invention unless otherwise noted. Furthermore, the techniques and mechanisms of the present technology will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

The present technology relates to an automated variable pressure smoke/vapor machine characterized having preprogrammed controller that is capable of running computer generated instructions to execute continuously a number of leak tests at different pressure operating modes, where each leak test may have similar or different durations of time. For example, in a first pressure operating mode, the vapor machine may generate vapor at a first predefined test pressure or within a first predetermined pressure range, while in the second pressure operating mode, the vapor machine may generate vapor at a second predefined test pressure or a second predetermined pressure range. The vapor machine has a pressure regulator responsive to activation of an operating mode to cause the vapor machine to switch between different pressure operating modes. The time for running each leak test may be selected by a user, or may be preprogrammed into the controller memory and selected by default by the controller if the user doesn't instruct the vapor machine otherwise by inputting a different leak test time.

The vapor producing liquid may be a liquid which, when heated to a certain temperature, will produce a non-toxic smoke. Suitable liquids include non-toxic petroleum based oils, such as mineral oil (baby oil) for example.

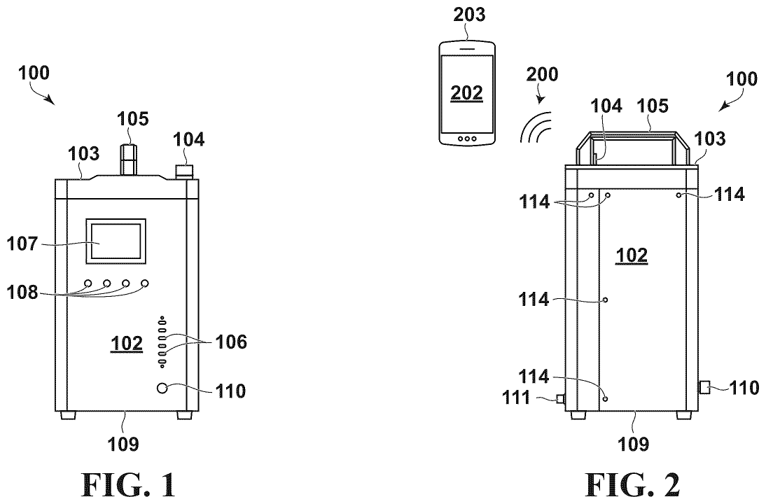

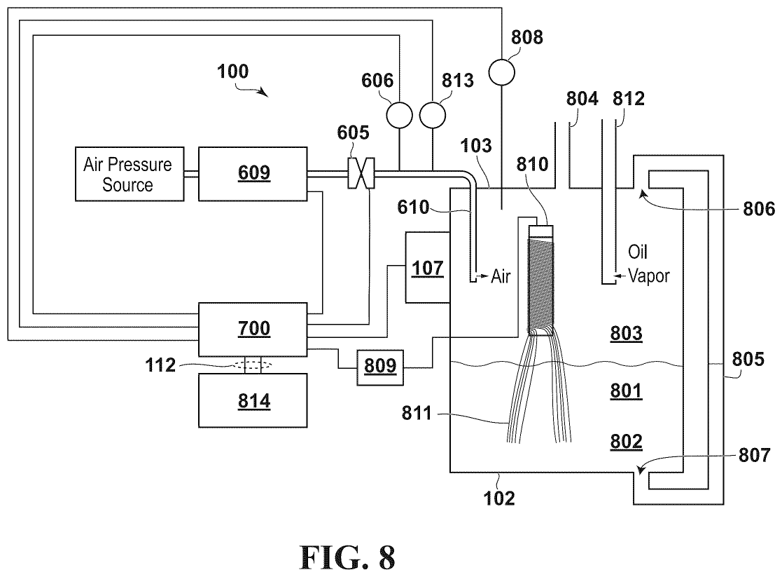

Referring to FIGS. 1 to 5, there is shown a vapor machine 100 according to an embodiment of this technology. There are other embodiments of this technology that may be implemented using various designs of the exterior form of the vapor machine 100 and various disposition of the machine's elements on its housing 102. In FIG. 1 the illustrated embodiment of the vapor machine 100 has a housing 102 that is covered by a top cover 103. The top cover 103 may be removable for maintenance or cleaning of the vapor machine 100 or for filling of the liquid reservoir 801 with liquid 802, which is shown in FIG. 8.

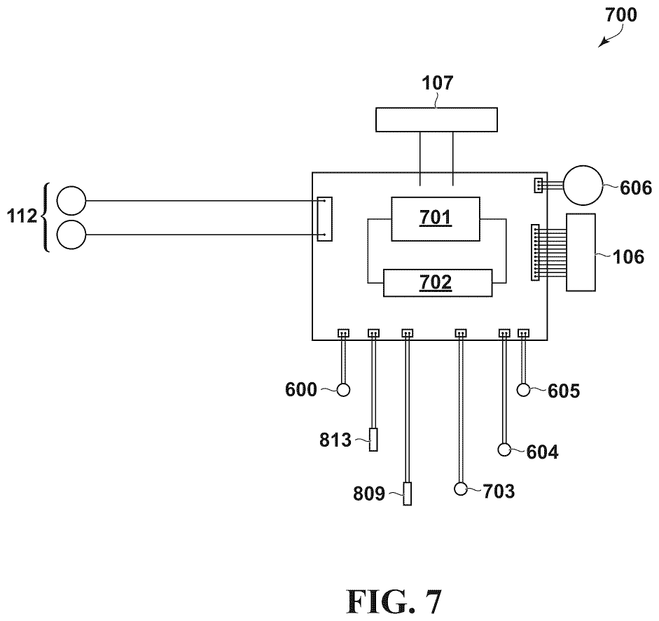

As shown in FIG. 1, the vapor machine 100 has a display 107 that is mounted to the housing 102. The display 107 is fixed to the housing 102 to prevent it from detaching and experiencing possible damage. It is understood that the display 107 may be detachable if it may be wirelessly connected via a wireless connection to a controller 700, which is shown in FIG. 7. The display 107 may be secured to the housing 102 with screws (not shown), or glue (not shown), or may be otherwise attached. The display 107 is shown in FIG. 1 as part of the machine 100. The present technology includes an embodiment when the display 107 is not a physical part of the machine 100, rather the display 107 is a secondary device display 202 of a secondary device 203 as is shown in FIG. 2.

In the exemplary embodiment shown in FIG. 2, when the vapor machine 100 has a secondary device display 202 that is not mounted to the housing 102 and is rather connected wirelessly to the controller 700 (FIG. 7) via a wireless connection 200, the wireless connection 200 includes any wireless connections that exists today or that may exist in the future. Referring to FIG. 2, the secondary device 203 may be configured to give commands to the controller 700 (FIG. 7) of the vapor machine 100 in order to provide instructions to the vapor machine 100 on the type of the leak test that that the user wants to perform. The secondary device 203 may be a mobile phone, a tablet, a laptop, a stationary computer, a smartwatch etc. The communication between the secondary device 203 and the controller 700 is described in more detail hereinbelow.

In another embodiment that is not shown in the figures, the vapor machine 100 may have both the display 107 mounted to the housing 102 as is shown in FIG. 1 and the secondary device display 202 that is wirelessly connected to the controller 700 as is shown in FIG. 2. The two displays 107 and 202 may complement each other or may be used for mirroring each other. Any one of the displays 107 or 202 may have a touch screen to give commands to the controller 700 m or both displays may have touch screens.

In FIG. 1, the display 107 is not shown to have a touch screen, as such control buttons 108 are mounted to the housing 102. The buttons 108 are connected to the controller 700 and are configured to provide commands thereto. The buttons 108 may include an on/off button, a button for selecting an input, a button for scrolling between possible options that a user can select, and a button for going back in the menu in order to select other options. In an example of possible options that a user may select, the controller 700 may display on the display 107 the following, non-limiting options: leak test programs, operating pressures, which may be selected in either in psi, Bar or KPa, durations of test times in seconds or minutes, types of graphical representations that a user may choose as the output shown on the display 107, language of operation of the vapor machine 100, brightness of the display 107, choosing to run leak tests programs with vapor, without vapor, or via alternating vapor/air output from the vapor machine 100 into the fluid system of a vehicle that is being tested, operating temperatures in Celsius or in Fahrenheit, etc. It is understood the controller 700 may allow the user to input via the buttons 108 other possible options that are not outlined above.

FIG. 1 also shows that the vapor machine 100 has an LED leak size indicator 106 that may be a set of light-emitting diodes (hereinafter: LED) configured to selectively indicate at least a first leak size and a second leak size. It is understood that the LED leak size indicator 106 may be any set of any light emitting devices that light selectively, that are positioned in a line, in a grid, in an arc, or otherwise to perform this function. The light emitting devices may be any suitable devices, which include, but not limited to the LE Ds, small light bulbs, halogen bulbs, high intensity discharge lamps, etc. The LED leak size indicator 106 is connected to the controller 700, as is shown in FIG. 7, and each of the LEDs is actuated by an electronic signal from the controller 700. The controller 700 actuates selectively a given LED or a set of LEDs that illuminate in response to being actuated, thus indicating to a user the size of the leak in the fluid system of a vehicle that is being tested. Lighting on of a single LED may indicate one leak size. Also, the controller 700 may be programmed such that both: lighting one LED indicates a specific leak size, as well as lighting two or more LEDs indicates another specific leak size.

In the exemplary embodiment of the vapor machine 100, the LED leak size indicator 106 is a row of six LEDs, the row of the six LEDs extends from the bottom 109 of the vapor machine 100 towards the top cover 103. For example, in a non-limiting embodiment of the controller 700 having programmed instructions for operating the LED leak size indicator 106, may include the following outputs:
When the 1^{st} LED from the bottom 109 of the vapor machine 100 turns green, it indicates to a user that the fluid system of a vehicle that is being tested has no leaks;
When the 2^{nd} LED from the bottom 109 of the vapor machine 100 turns yellow, it indicates to a user that the fluid system of a vehicle that is being tested has a micro leak;
When the 2^{nd} and 3^{rd} LEDs from the bottom 109 of the vapor machine 100 turn yellow, it indicates to a user that the fluid system of a vehicle that is being tested has a small leak;
When the 2^{nd} to 4^{th} LEDs from the bottom 109 of the vapor machine 100 turn to red, it indicates to a user that the fluid system of a vehicle that is being tested has a medium leak;
When the 2^{nd} to 5^{th} LEDs from the bottom 109 of the vapor machine 100 turn to red, it indicates to a user that the fluid system of a vehicle that is being tested has a medium-large leak;
When the 2^{nd} to 6^{th} LEDs from the bottom 109 of the vapor machine 100 turn to red, it indicates to a user that the fluid system of a vehicle that is being tested has a large leak.

It understood that the LED leak size indicator 106 may be actuated during every leak test that may be performed by the vapor machine 100, or the LED leak size indicator 106 may be selectively actuated for a set of predefined types of leak tests that may be performed by the vapor machine 100.

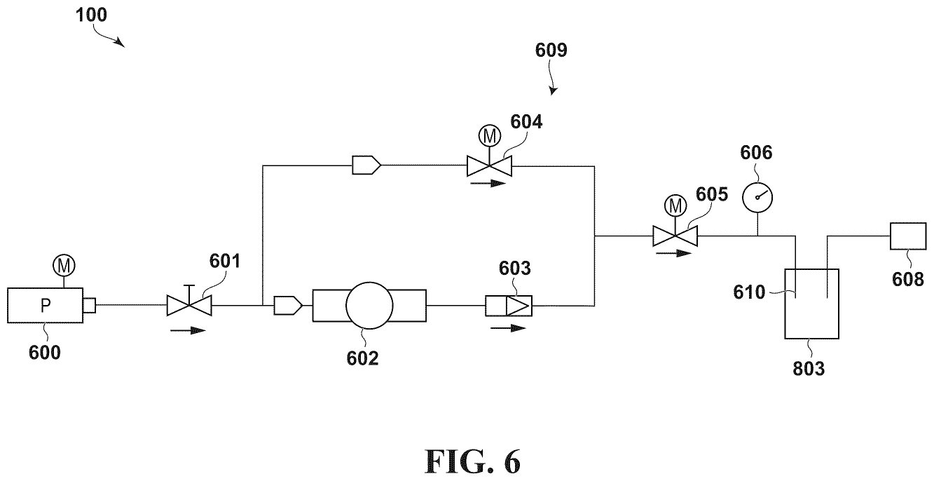

Furthermore, FIG. 1 shows a knob 110, which is a flow control knob that is positioned closer to the bottom 109 of the vapor machine 100. It is understood that the knob 110 may be positioned anywhere on the housing 102 as long as it controls the flow in the flow path as described in more detail below. In the embodiment shown in FIG. 6, the knob 110 controls the flow valve 601 that is proximate the air pump 600. Thus, the knob 110 controls whether pressurized gas flows into the vapor generating chamber 803 or not, regardless of the pressure regular 609 that is located downstream of the flow valve 601.

In the embodiment illustrated in FIG. 1, the knob 110 is manually actuatable by a user. In other embodiments, the vapor machine 100 may not have the knob 110 (not shown) to control the flow valve 601 and instead the flow of the pressurize gas may be controlled via electronic signals emanating from the controller 700.

In the present example, the top cover 103 is removably secured to the housing 102, for example by using mechanical fasteners (e.g. screws and mating through-holes, clips, mating threaded portions, etc.). A seal or gasket may be used to seal the interface between the top cover 103 and the housing 102.

Referring to FIGS. 1-5, the top cover 103 has a cap 104. The cap 104 is provided in the top cover 103 to seal a fill hole 804 (shown in FIG. 8) that is used for filling the liquid reservoir 801 with a liquid 802, which is shown in FIG. 8. The cap 104 is configured for removably sealing the fill hole 804. Sealing the cap 104 creates an airtight lock that prevents air, vapor or any other gas that are used to operate the vapor machine 100 from escaping the vapor generating chamber 803, which is shown in FIG. 8. The airtight locking may be achieved by using any known technique that includes: a friction seal, a screwing type of seal—when a thread of the cap 104 is matched with a threaded extending or protruding portion (not shown) of the top cover 103, a clipping type of mechanism for sealing the cap 4, etc.

Referring to FIGS. 1-5, the top cover 103 is shown to have a handle 105, which is illustrated as an inverted u-shaped handle that is bolted to the top cover 103 by bolts 106 (FIG. 5). It is understood that the handle 105 may be of any suitable shape that achieves the function of a handle, for example, it may be in a shape of a hook, a loop, a demi-circle, a trapeze, etc.

Optionally, an analog pressure gauge (not shown) may be attached to the top cover 103, for measuring and displaying the real-time pressure in the vapor generating chamber 803. It is understood that an analog pressure gauge may also be mounted to the housing on its front or its side (not shown).

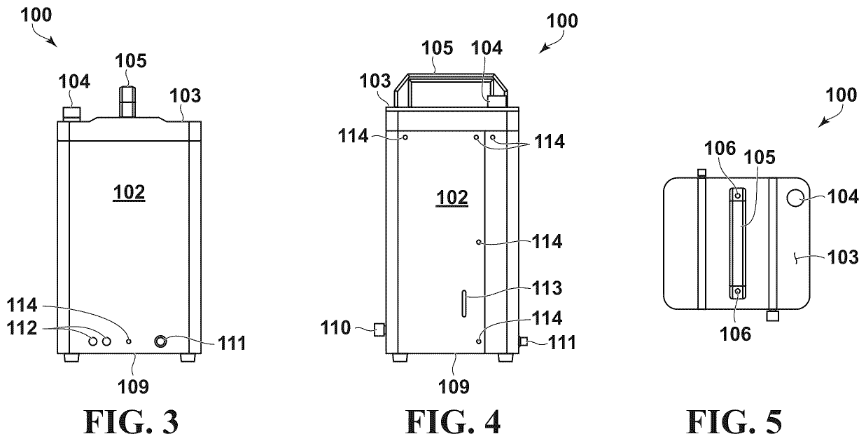

FIG. 3 illustrates the vapor machine 100 from the back and it is shown to have an outlet conduit 111 for connecting one end of a hose or any other suitable flexible tube that has another end connected to a fluid system of a vehicle that is being tested for leaks. The outlet conduit 111 is shown to be proximate the bottom 109 of the vapor machine 100, however, it is understood that the outlet conduit may be positioned elsewhere. For example, in FIG. 8, another embodiment of the outlet conduit 812 is shown to be positioned proximate the top of the vapor machine 100 extending through the top cover 103.

FIGS. 2 and 4 illustrate the vapor machine 100 from its left and right side respectively. FIG. 4 shows that housing 102 of the vapor machine 100 has an opening 113 for the liquid level indicator 805. The opening 113 is an elongated cut in the side of the housing 102 that allows the user to see the gauge of the liquid level indicator 805. In alternative embodiments, when other types of liquid level indicators liquid level indicator 805. The opening 113 may also be circular, rectangular, oval, etc. In cases, when the liquid level indicator 805 is an electronic sensor (not shown) that is connected to the controller 700, such electronic sensor collects the information about the level of liquid 802 inside the liquid reservoir 801 and sends measurements to the controller 700 via electronic signals, which are then processes and a graphical representation of the liquid 802 level is displayed on the display 107. In case of an electronic sensor, the housing 102 will not have any openings such as the opening 113, which makes the manufacturing of the vapor machine 100 simpler.

FIG. 3 shows that the vapor machine 100 has terminals 112 for connecting the vapor machine 100 to a power supply. The pair of terminals 112 are provided proximate the bottom 109 of the vapor machine 100, extending through the housing 102 to connect to a pair of electrical inputs on the controller 700. In order to power the vapor machine 100, the terminals 112 are electrically connectable to a power supply, such as a battery, a transformer or an electrical outlet, for example via extension cables.

FIGS. 2, 3 and 4 show that the vapor machine 100 has bolts 114 that connect different parts of the housing 102 together. The top cover 103 and housing 102 may be made of aluminum or of any other suitable material, such as stainless steel or plastic, as such, parts thereof may be made from sheets that are bolted together, screwed or otherwise secured. It is understood the housing 102 and the top cover 103 may be manufactured by any suitable process. In the example shown in FIGS. 1-5, the housing 100 is made of several parts that are secured together by bolts 114.

In a non-limiting embodiment of the vapor machine 100, FIG. 6 shows a schematical representation of different components of the vapor machine 100. There's illustrated an air pump 600 that is used to compress air or any other gas that the air pump is connected to, which, may include inert gasses, mixtures thereof or other gases known in the art of vapor generating machines. The air pump 600 is shown as being part of the vapor machine 100, however, it is understood that alternative embodiments include an external air pump (not shown) that may connected to the vapor machine 100 via a hose (not shown).

In the exemplary embodiment shown in FIG. 6, the air pump 600 is connected to the flow valve 601, which is controlled by the knob 110 to control the flow from the air pump 600 to other parts of the vapor machine 100. While in operation, the know 110 is fully turned to open, thus allowing for maxim airflow to be conveyed via the flow valve 601 from the air pump 600 to the housing 102. The air pump 600 is controlled by the controller 700 and is responsive to manual actuated input via the buttons 108 that allow the user to set a desired operating pressure for the vapor machine 100.

In order to run a variety of leak tests, the vapor machine 100 has a pressure regulator 609, which includes several components: a pressure sensor 606 that is in fluid communication with an electrically controlled valve 605, both of which are in fluid communication with a combination consisting of a solenoid valve 604, a pressure relief valve 602 and a check valve 603. It is understood that the pressure regulator 609 may consist of a single component, such as the electrically controlled valve 605, the combination of the pressure sensor 606 and the electrically controlled valve 605. In the embodiment shown in FIG. 6, the pressure relief valve 602 and the check valve 603 are connected in series to each other. The pressure relief valve 602 and the check valve 603 are connected in parallel to the solenoid valve 604. The parallel arrangement of the solenoid valve 604 with the pressure relief valve 602 and the check valve 603 are in fluid connection in series with the flow valve 601 and the electrically controllable valve 605, which is represented in FIG. 6 as a solenoid valve.

In order to control the pressure changes while running consecutive leak tests, the controller 700 selectively actuates the electrically controllable valve 605, the solenoid valve 604 and the pressure relief valve 602. The pressure relief valve 602 allows the vapor machine 100 to effectively release excess pressure while performing leak tests, for example. It also acts as a safely valve that releases excess pressure when dangerous pressure buildup my cause damage to the vapor machine 100 or to the fluid system of a vehicle that is being leak tested.

FIG. 6 also shows that the vapor machine 100 has a pressure sensor 606. The pressure sensor is connected to the controller 700. The pressure sensor 606 is configured to measure the pressure inside the vapor generating chamber 803 and generating electronic signals that correspond to the pressure measurements, the electronic signals are then being sent to the controller 700. Upon receiving the electronic signals from the pressure sensor 606 the controller 700 executes instructions that may actuate any of the following: electrically controllable valve 605, solenoid valve 604, check valve 603, pressure relief valve 602 or the air pump 600. For example, the controller 700 may either actuate the electrically controllable valve 605 to affect the gas flow into the chamber 803 or to not actuate the electrically controllable valve 605 not to affect the gas flow into the chamber 803. For example, the controller 700 may close the electrically controllable valve 605 to prevent any gas flow from the air pump 600 into the chamber 803. For example, the controller 700 may actuate the pressure relief pump 602 to evacuate an amount of gas from the pressure regulator 609.

It is understood that the electrically controllable valve 605 is in fluid connection with the vapor generating chamber 803 and controls the amount of pressurized gas that is conveyed from the air pump 600 to the vapor generating chamber 803. While performing leak tests that measure pressure, the controller 700 may actuate the electrically controllable valve 605 as the main element located upstream of the pressure sensor 606, in order for the vapor machine 100 to measure pressure decay in the fluid system that is being tested.

Referring to FIG. 7, there is shown the controller 700 that is connected to various parts of the vapor machine 100 as is described in more detail below. The controller 700 has a processor 701 and a memory 702. The processor 701 executes instructions that are stored in the memory 702. The controller 700 collects electric signals generated by the pressure sensor 606, the temperature sensor 808, or the buttons 108 and outputs electric signals to actuate the LED leak size indicator 106, the electrically controlled valve 605 or any other part of the pressure regulator 609, the fan 703, the heating switch 809, the air pump 600 or other part of the vapor machine 100. The processor 701 also generates data that is transmitted to the display 107 and is shown to the user via graphical representations displayed on the display 107. The terminals 112 extend from the controller to the outer side of the housing 102 as is shown in FIG. 3 and are used to power the vapor machine 100.

The controller 700 may be programmed to implement various various functionalities of the vapor machine 100. For example, such functionalities include taking real-time measurements from various sensors, storing these measurements in the memory 702 and using the processor 701 to perform calculations based on the measurements, in response to which, the processor 701 may execute various instructions that lead to the controller 700 actuating different parts/elements of the vapor machine 100 in an automated manner.

In addition to the functions outlined above, the controller 700 may be configured to measure the surface temperature of the heating element 810; measure the flow from the vapor generating chamber 803; turn on and off one various indicator lights and/or sounds; detect the polarity of and turning on and off the power to the heating element 810 based on temperature and/or time criteria; detect activation of the power switch, the latter being either provided via a prescribed button 108 on the housing 102 or via wireless communication 200 via the secondary device 203; setting or adjusting a set-point of any of the solenoid valves; control and/or set an the pressure regulator 609; control the operation of one or more internal 600 or external sources of pressurized air; turn on and off auditory signals; implement a fail safe mode; etc.

The controller 700 of the vapor machine 100 may be implemented in hardware, software or a combination thereof, either locally as an integral of the vapor machine 100, remotely from the vapor machine 100 (for example via a remote control) or both locally and remotely. The non-limiting example of an implementation of the controller 700 shown in FIG. 7. This example shows that the controller 700 is fully implemented within the vapor machine 100, by a printed circuit board having a power switch, where this power switch is operably coupled to a manually activatable on/off button or switch 108 located on the housing 102, or alternatively on the top cover 103 (not shown). In another non-limiting example of implementation, the control unit of the vapor machine 100 includes both a printed circuit board that is located within the vapor machine 100 and a remote controller 203 in wireless communication 200 with a printed circuit board, where this remote controller 203 implements a plurality of controls (including for example an on/off control) that are activatable by a user of the remote controller 202 to transmit wireless control signals to the circuit board of the controller 700 for controlling the operation of the vapor machine 100. In FIG. 1, the remote controller 203 is illustrated as a mobile telephone that has a vapor machine controlling application installed thereon.

The fan 703 is may be positioned proximate the controller 700 and be responsive to the controller 700 heating to a threshold temperature before being activated by the controller 700 to cool the processor 701.

In an exemplary embodiment, FIG. 8 illustrates that the terminals 112 are connected to an external power source 814. As is mentioned above, the power source 814 can be a battery or any other power source that is properly converted to the operational voltage of the vapor machine 100, which may be 12 volts, for example, any other power source may be an AC or a DC power source.

As shown in FIG. 8, the housing 102 defines a liquid reservoir 801 within the vapor generating chamber 803. The liquid reservoir 801 is configured for holding vapor producing liquid 802. The fill hole 804 is provided in the top cover 103 to fill the liquid reservoir 803 with a vapor producing liquid 802. For example, the liquid 802 may be poured into the fill hole 804 of the liquid reservoir 801 of the vapor generating chamber 803. In the example shown in FIG. 8, the fill hole 804 is provided with a tubular extension extending from the top cover 103 that may be sealed shut using a screw-on cap (not shown in FIG. 8). Alternatively, in the absence of a fill hole 804, the top cover 103 of the housing 102 may be removed to allow liquid 802 to be poured into the liquid reservoir 801.

As shown in FIG. 8, in an exemplary embodiment, the machine 100 may include a liquid level indicator 805 allowing the observation of a level of liquid 802 in the liquid reservoir 801 without removing the top cover 103 from the housing 102. A non-limiting example of the liquid level indicator 805 is shown as a conduit consisting of a tube of transparent plastic material, mounted to the exterior of the housing 102 and extending between the port 806 proximate the top cover 103 and a port 807 proximate the bottom of the housing 102, the ports 806 and 807 fluidly connecting to the liquid reservoir 102. For example, the level of the liquid 802 may be seen via the tube of the level indicator 805. Alternatively, the liquid level indicator 805 may be a dipstick, where the shaft of the dipstick would extend from the top cover 103 via the liquid through the chamber 803 and into the liquid reservoir 801. In another alternative a transparent material (not shown) may be provided in the housing 102 as a liquid level indicator 805 to allow visual observation of the liquid 802 therethrough, however, an embodiment where the housing has an elongated opening 113 that allows the user to visually observe the liquid level indicator 805 is shown in FIG. 4.

In another alternative, the level indicator 805 may be a liquid level sensor (not shown) that is positioned in the liquid reservoir 801. The liquid level sensor generates electronic signals indicating the level of the liquid 802 within the liquid reservoir 801. The electronic signals are transmitted to the controller 700 and processes thereby to display liquid level related information on the display 107. For example, when the liquid level of the liquid 802 is sufficiently low in the reservoir 801, the controller 700 may provide a visual or an audio signal to the user indicating to the user that the liquid level is low. In other examples, the controller 700 may be programmed to turn of the heating switch 809 to stop the heating element 810 from receiving electric power.

As shown in FIG. 8, the heating element 810 is positioned in the vapor generating chamber 803. The heating element 810 has a liquid transfer device 811 that is attached to the heating element 810 and that extends from the heating element 810 towards the bottom of the liquid reservoir 801 such that the liquid transfer device 811 is in contract with the liquid 802. The liquid transfer device 811 may use capillary action to deliver the vapor producing liquid 802 from the liquid reservoir 801 to the heating element 810. As is well known in the art, capillary action refers to the motive force on a liquid produced by the surface tension between the liquid and a surface, in this case the smoke producing liquid and the material of the liquid transfer device 811.

In order to prevent the generation of unwanted combustion smoke and wearing of the liquid transfer device 801, the liquid transfer device 811 may be composed of any suitable material thereto, including a material that is able to withstand high temperatures while producing sufficient capillary action required to deliver the liquid 802 from the liquid reservoir 801 to the heating element 810. For example, the liquid transfer device 811 may be bundle of fibreglass fibers that are not braided, twisted or woven, or any other suitable material. In an example of unbraided fiberglass its fibers are collected and arranged sufficiently close to each other to wick the vapor generating liquid 802 up from the liquid reservoir 801 and onto the heating element 810. The loose tightness of the fibers allows for capillary action to take place. The ability of the liquid transfer device 811 to wick the liquid 802 also depends on the properties of the liquid 802 itself. For example, while using the baby oil relatively loose fibreglass fibers of the liquid transfer device 811 are drawn one to another by the surface tension of the liquid 802, thus producing sufficient wicking of the liquid 802. Fiberglass is an example of a material that may be used at temperatures of around 300 degrees Celsius that is sufficient for operating the vapor generating machine 100. Alternatively, a woven wick, twisted or braided cord made of suitable wicking fibers can be used as long as its temperature resistance and its wicking ability are sufficient for the operation of the vapor generating machine 100. In the example shown in FIG. 8, the liquid transfer device 811 comprises a wicking bundle of fiberglass fibers that is wrapped around the heating element 810 substantially covering the heating element 810. The wicking fiber bundle is tightly wrapped around the heating element 810 and is held thereon by any suitable technique, for example, the wicking fiber bundle may be tied into knots at the bottom and at the top of the heating element 810. It is understood that different techniques may be used to wrap and tie the wicking fiber bundle to the heating element 810. Installation and/or replacement of the liquid transfer device 811 may not require special tools or abilities and may be easily performed by unskilled workers.

It is understood that the heating element 810 may be any suitable heating element in the smoke machine industry. For example, the heating element 810 may be a ceramic heater that may include a composite ceramic material that may have iron or steel flakes as a conductive filler, as is known in the art of ceramic heating elements. Alternatively, an electrical resistive heater element core may be surrounded by ceramic material, wherein the ceramic material transmits the heat from the resistive heater element and provides a high temperature on the surface of the heating element for vaporizing the smoke producing liquid. In another example, the heating element 810 may be a coil of resistive wire that generates heat when an electrical current is conducted therethrough by placing an electrical voltage across the wire (not shown).

In the embodiment shown in FIG. 8, the vapor machine 100 has the outlet conduit 812 that is positioned on the top of the housing 102 and extends though the top cover 103. The outlet conduit 812 has an extended portion that is configured to attach thereto one end of a hose or any other flexible tube that has another end attached to a fluid system that is being tested. The attachment of the extended portion of the outlet conduit 812 is done in any suitable matter as long as no air/gas/vapor escapes at the attachment point of the outlet conduit 812 and the end of the hose. For example, the hose may be friction fitted to the outlet conduit 812 or it may be connected via a suitable adaptor (not shown).

In the embodiment shown in FIG. 8, the heating element 810 is electrically connected to the heating switch 809 that is in turn connected to the controller 700. The controller 700 actuates the heating switch 809 to supply electric power to the heating element 810 in order to generate the vapor from the liquid 802. In the illustrated embodiment, the vapor machine 100 is configured to controllably provide electric power to the heating element 810 to generate vapor and avoid the creation of any of toxic fumes and the over pressurization of the chamber 802. For example, the controller 700 provides a current to the heating switch 809 that results in the heating of the heating element 810 to a controlled temperature sufficient to create evaporation of the vapor-producing liquid 802 while avoiding: the combustion of the vapor-producing liquid 802, the combustion of the liquid transfer device 811, and the boiling of the liquid 802 in the liquid reservoir 801. The controller 700 is controlled to provide an electrical current that maintains the temperature of the heating element 810 within a predetermined safe range. For example, the controller 700 may provide a constant voltage that generates current in the heating switch 809 that allows the heating element 810 to heat to a temperature at which the liquid 802 starts evaporating.

In order to convey the vapor produced by the vapor machine 100 into a fluid system of a vehicle to check for leaks, the air pump 600 conveys the pressurized gas, which may be air, into the vapor generating chamber 803 through the gas inlet 610, and then from the vapor generating chamber 803, this gas or the mixture of this gas and vapor are conveyed into the fluid system of a vehicle via a hose that is connected to the outlet conduit 111, whereby the other end of the hose is connected to an inlet of the fluid system of the vehicle. The air pump 600 and the fluid system of the vehicle are in fluid communication, thus defining a fluid path of the gas.

A flow meter 813 shown in FIG. 8 may be included in the vapor machine 100. For example, a digital flow meter 813 may be connected to the controller 700 and may integrated as an element of the pressure regulator 609 or the flow meter 813 may be integrated anywhere along the fluid path. In another example, an analog flow meter (not shown) may be integrated along the flow path and secured outside the housing to provide the user with a possibility to visually observe the flow meter. An analog flow meter may be a graduated floating ball flow meter, an electronic flow meter 813 may be electrically connected to the controller 700, or some other type of meter capable of measuring fluid flow rates.

The controller 700 is programmed to automatically perform various leak tests. In order to activate any of the leak test programs stored in the memory 702, the user needs to indicate to the processor 701 the type of leak test the user wants to run and the initial parameters of the leak test. The type of leak test and the initial parameters are determined by the user and are dependent on the fluid system of a vehicle that needs to be tested. For example, some fluid systems may be tested with a smoke/vapor test, others with an air test and others with both. The pressure ranges for testing different fluid systems in different vehicles may vary significantly. For example, testing turbined engines requires different pressure conditions than testing engines without turbines.

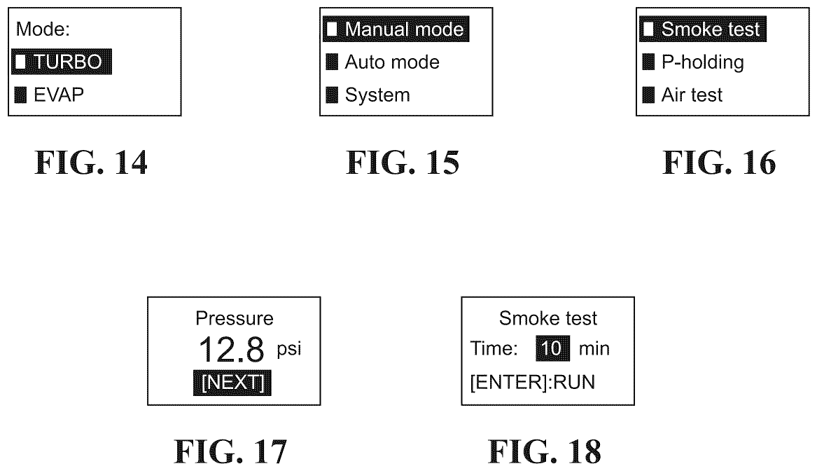

In the embodiment shown in FIG. 14, the vapor machine 100 may have at least two modes of operation: a Turbo mode and a EVAP mode as shown in FIG. 14, or more modes, for example, Turbo, EVAP, Manual mode and Auto Mode as shown in FIG. 15. The EVAP mode is suited for testing evaporative emission control systems and the Turbo mode is suited for testing vehicle engine systems having turbines. It is understood that in other embodiments, the vapor machine 100 may have other modes of operation, for example, normal mode, high pressure mode, low pressure mode, a high temperature mode, a low temperature mode, etc. Alternatively, the operating modes may also be divided by ranges of operating pressures, for example, 0.1 to 0.2 psi, 0.2 to 0.4 psi, 0.4 to 0.6 psi, etc. Other modes may include 6 to 9 psi, 9 to 12 psi, 12 to 16 psi, 16 to 20 psi, etc. up to 36-40 psi.

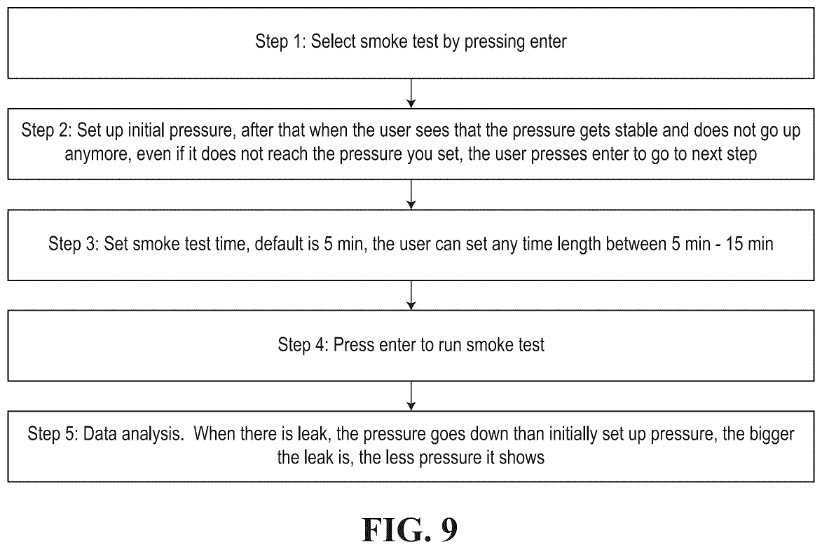

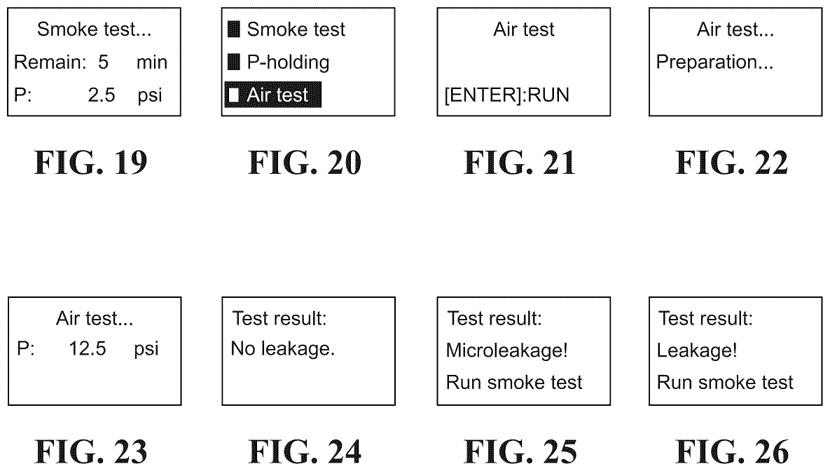

FIG. 9 shows exemplary steps that a user may follow to perform a smoke/vapor leak test with the vapor machine 100. During a smoke/vapor leak test the vapor machine 100 generates vapor that is pumped into the fluid system of a vehicle that needs to be tested. It is understood that the controller 700 may be programmed in a different manner that will make user may take other kind of steps to instruct the vapor machine to perform a vapor leak test. The steps illustrated in FIG. 9 include:
Step 1: select “Smoke test” option on the display 107 by pressing the corresponding buttons 108 as is shown in FIG. 16.
Step 2: set up the initial pressure to run the smoke leak test by selecting the pressure values via the buttons 108 as is shown in FIG. 17. After selecting the initial pressure, the controller 700 of the vapor machine 100 actuates the air pump 600 and the pressure regulator 609 to increase the pressure in the vapor generating chamber 803 and consequently the fluid system of the vehicle that is in fluid connection with the vapor generating chamber 803 via the outlet conduit 111 and a hose. The display 107 will indicate the increase in pressure that is measured by the pressure sensor 606. After a certain time, the pressure will stabilize at or below the initial pressure that the user set. It is normal for the pressure to be lower than the initial pressure set by the user, as the vapor machine 100 automatically measures the safe pressure range that the smoke test should be performed with. After the pressure measurement displayed on the display 107 stabilizes, the user selects the “next” or “enter” by pressing the corresponding button 108.
Step 3: set smoke/vapor test time. The default time to perform this test is 5 minutes. However, the user may set any time of the duration of the test between 5 minutes and 15 minutes as is shown in FIG. 18.
Step 4: the user presses “Enter” to run smoke/vapor test by selecting “next” or “enter” by pressing the corresponding button 108. When the vapor machine 100 runs the smoke test, the controller 700 closes the electrically controllable valve 605 and the pressure sensor 606 measures any changes in the pressure in the vapor generating chamber 803 and the fluid system that is in fluid connection with the vapor generating chamber 803. During the smoke/vapor leak test, the vapor machine 100 will generate vapor by heating up the heating element 810 and evaporating the liquid 802 as described in more detail above. The vapor will then be mixed with the air or gas that is being pumped by the air pump 600 into the fluid system of the vehicle that is being tested.
Step 5: Data analysis. When the smoke/vapor test is running, the display will display in real time pressure values and time elapsed from the duration of the test as is shown in FIG. 19. At the end of the leak test, the display will show a pressure decay graph 1300 as is shown in FIG. 13. The user may interpret the results as follows: when there is leak, the pressure goes down than the initially set up pressure. The bigger the leak is, the less pressure remains in the vapor generating chamber 803.

Upon completion of the leak test or during the operation of the leak test, the user can observe the fluid system of the vehicle to try to find any vapor exhausting from a hole in the fluid system. For instance, if the user does not find any vapor exhausting from a hole, however, if the display 107 shows that there is a leak in the fluid system, the user can continue running the smoke/vapor test and observing the fluid system to try to locate the leaking hole.

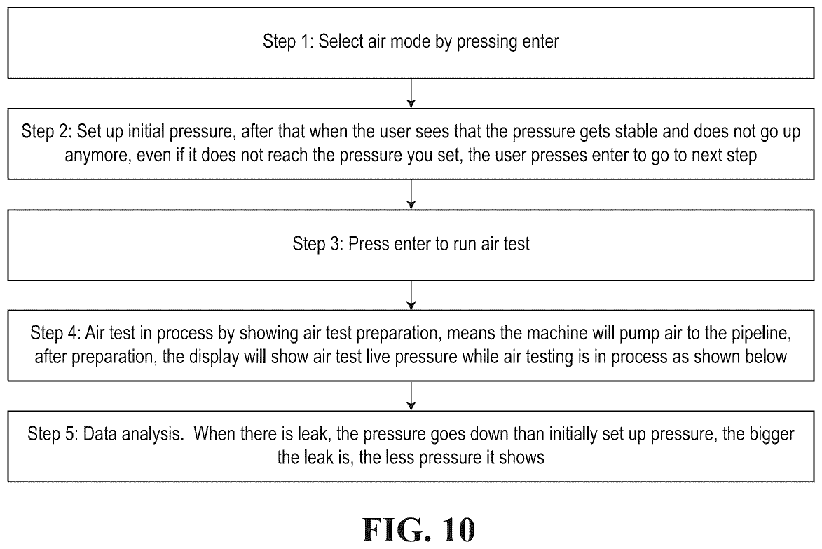

FIG. 10 shows exemplary steps that a user may follow to perform an air leak test with the vapor machine 100. During the air leak test the vapor machine 100 does not generate any vapor, as such the vapor machine 100 pumps air or any intern gas into the fluid system of a vehicle that needs to be tested. It is understood that the controller 700 may be programmed in a different manner that will make user may take other kind of steps to instruct the vapor machine to perform an air leak test. The steps illustrated in FIG. 10 include:
Step 1: select “Air test” option on the display 107 by pressing the corresponding buttons 108 as is shown in FIG. 20.
Step 2: set up the initial pressure to run the smoke leak test by selecting the pressure values via the buttons 108 as is shown in FIG. 17. After selecting the initial pressure, the controller 700 of the vapor machine 100 actuates the air pump 600 and the pressure regulator 609 to increase the pressure in the vapor generating chamber 803 and consequently the fluid system of the vehicle that is in fluid connection with the vapor generating chamber 803 via the outlet conduit 111 and a hose. The display 107 will indicate the increase in pressure that is measured by the pressure sensor 606. After a certain time, the pressure will stabilize at or below the initial pressure that the user set. It is normal for the pressure to be lower than the initial pressure set by the user, as the vapor machine 100 automatically measures the safe pressure range that the air test should be performed with. After the pressure measurement displayed on the display 107 stabilizes, the user selects the “next” or “enter” by pressing the corresponding button 108.
Step 3: the user presses “Enter” to run the air test by selecting “next” or “enter” by pressing the corresponding button 108 as is shown in FIG. 21. When the vapor machine 100 runs the air test, the controller 700 closes the electrically controllable valve 605 and the pressure sensor 606 measures any changes in the pressure in the vapor generating chamber 803 and the fluid system that is in fluid connection with the vapor generating chamber 803.
Step 4: when the air test is in progress the display 107 will show in real time different stages of the air test, for example: “air test preparation” indicates that the machine pumps pump air into the fluid path (FIG. 22). After preparation stage, the display will show air test live pressure measurements while air testing is in progress (FIG. 23).
Step 5: Data analysis. When the air test is running, the display will display in real time pressure values. At the end of the air test, the display will show a pressure decay graph 1300 as is shown in FIG. 13. The user may interpret the results as follows: when there is leak, the pressure goes down than the initially set up pressure. The bigger the leak is, the less pressure remains in the vapor generating chamber 803. The display may also show results as follows: “no leakage” (FIG. 24), “microleakage! Run smoke test” (FIG. 25, “Leakage! Run smoke test” (FIG. 26).
When there is leak, the pressure goes down than initially set up pressure, the bigger the leak is, the less pressure it shows.

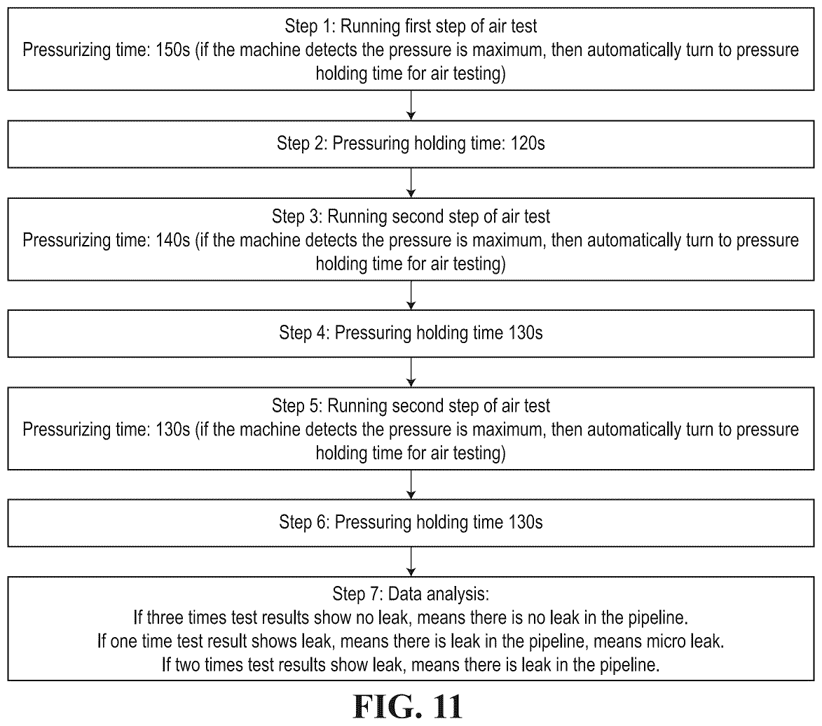

By default, the air test will run three consecutive times during the total duration of the test that may be in the range between 10 minutes and 15 minutes. In an exemplary embodiment the test may be 13.5 minutes. An example of the instructions that the controller 700 may generate include the following as is schematically shown in FIG. 11:
1) Running the air test for the first time out of the three consecutive times:
Set of instructions 1: actuate the elements of the vapor machine 100 for a pressurizing time of up to 150 seconds to the set pressure. If the pressure sensor 609 detects that the pressure is at maximum in the system consisting of the vapor machine 100 and the fluid system of a vehicle, then automatically stop pressurizing and activate elements of the vapor machine 100, including the electronically controlled valve 605 to hold the maximum achieved pressure pressure for a holding time of 120 seconds.
Set of instructions 2: collect pressure and/or flow data from the pressure sensor 609 and the flow sensor and send the collected data in form of electronic signals to the controller 700 for data processing.
Set of instructions 3: process collected data by the processor 701 and store data and the result of the processing in the memory 702.
2) Running the air test for the second time out of the three consecutive times:
Set of instructions 1: actuate the elements of the vapor machine 100 for a pressurizing time of up to 140 seconds to the set pressure. If the pressure sensor 609 detects that the pressure is at maximum in the system consisting of the vapor machine 100 and the fluid system of a vehicle, then automatically stop pressurizing and activate elements of the vapor machine 100, including the electronically controlled valve 605 to hold the maximum achieved pressure pressure for a holding time of 130 seconds.
Set of instructions 2: collect pressure and/or flow data from the pressure sensor 609 and the flow sensor and send the collected data in form of electronic signals to the controller 700 for data processing.
Set of instructions 3: process collected data by the processor 701 and store data and the result of the processing in the memory 702.
3) Running the air test for the third time out of the three consecutive times:
Set of instructions 1: actuate the elements of the vapor machine 100 for a pressurizing time of up to 130 seconds to the set pressure. If the pressure sensor 609 detects that the pressure is at maximum in the system consisting of the vapor machine 100 and the fluid system of a vehicle, then automatically stop pressurizing and activate elements of the vapor machine 100, including the electronically controlled valve 605 to hold the maximum achieved pressure pressure for a holding time of 140 seconds.
Set of instructions 2: collect pressure and/or flow data from the pressure sensor 609 and the flow sensor and send the collected data in form of electronic signals to the controller 700 for data processing.
Set of instructions 3: process collected data by the processor 701 and store data and the result of the processing in the memory 702.
4) Processing the collected data after the three air tests:
Set of instructions 1: compare the results of each of the three air tests to determine a possible leakage. General analysis may include the following:
   if each of the three times the air test results show no leak, this means that there is no leak in the fluid system of the vehicle being tested:
      Instructions: display on the display 107 the result as is shown schematically in FIG. 24;
   if one of the three times time the air test result shows a leak, this means that there is a microleak in the fluid system of the vehicle being tested:
      Instructions: display on the display 107 the result as is shown schematically in FIG. 25;
   if two of the times the air test results show a leak, this means that there is leak in the fluid system of the vehicle being tested:
      Instructions: display on the display 107 the result as is shown schematically in FIG. 26.

The vapor machine 100 may have an automated mode of operation. Selecting the automated mode or “auto mode” allows the user to instruct the controller 700 to perform the necessary tests for a given initial pressure. The automated mode is a combination of the air test and the smoke test that the vapor machine 100 selectively chooses depending on the programmed instructions stored in the memory 702. For example, the vapor machine 100 may initially run the air test three times as is outlined above and if no leak is identified, them the display 107 will indicate that there is not leak in the fluid system that is being tested. However, if after running the three air tests, the vapor machine 100 identifies a leak in the fluid system that is being tested, then the vapor machine 100 will show the air test results for a predetermined period of time, for example 2 to 5 seconds, as well as will indicate the leak size on the display 107 or on the LED leak size indicator 106, or both, and then the vapor machine will automatically start running the smoke/vapor test with the initial pressure that initially input by the user in the auto mode. Optionally, the user may also set the duration of the smoke test time during the auto mode testing. The default time may be set to 5 minutes, however, the user may select any time, for example, a time in a range of 5 to 15 minutes.

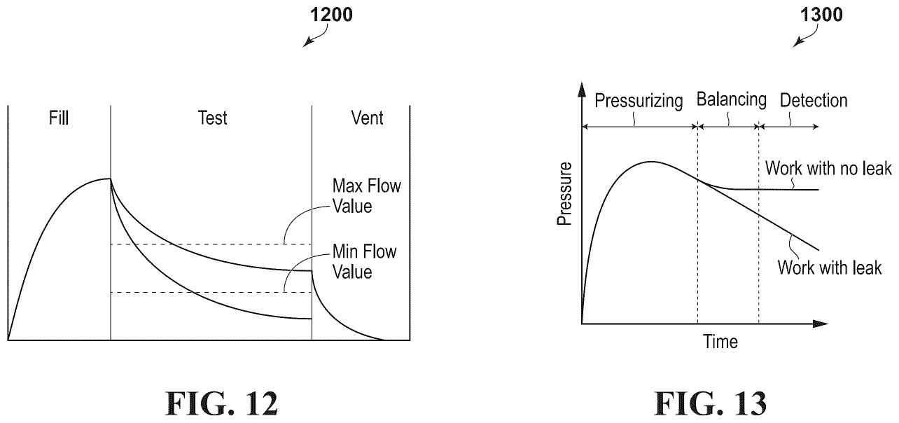

Additional features of the vapor machine 100 may include the function of displaying the graphical representation of the flow-based leak test 1200 that is shown in FIG. 12, where the flow meter 813 may measure a maximum flow value and a minimum flow value that may be used to calculate the leak size. The display 107 may also display a graphical representation of the pressure decay leak test 1300 that is shown in FIG. 13, where the difference between the pressures measured by the pressure sensor 609 may be used to calculate the leak size.

It is understood that the figures used herein depict merely illustrative examples of various implementations of the present technology. Thus, the description thereof that follows is intended to be only a description of illustrative examples of the present technology. This description is not intended to define the scope or set forth the bounds of the present technology. In some cases, what are believed to be helpful examples of modifications to the vapor generating machine may also be described hereinabove.

The methods of operating the controller 700 may be executed on the processor 701 and the memory 702, as well as a computer, a server, a smartphone, a tablet, a combination of electronic devices, or any suitable electronic system having at least some of the components, functions and/or modules described herein.

In the above description, numerous specific details are set forth, but embodiments of the invention may be practiced without these specific details. Well-known circuits, structures and techniques have not been shown in detail to avoid obscuring an understanding of this description. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “Connected” may indicate elements are in direct physical or electrical contact with each other as well as indicate elements that co-operate or interact with each other, but they may or may not be in direct physical or electrical contact. Also, while similar or same numbers may be used to designate same or similar parts in different figures, doing so does not mean all figures including similar or same numbers constitute a single or same embodiment.

One skilled in the art will appreciate when the description refers to receiving data that the controller executing the receiving of the data from the user or the sensors may receive an electronic (or other) signal. One skilled in the art will further appreciate that displaying data to the user via a user-graphical interface (such as the display of the vapor machine or a secondary electronic device or the like) may involve transmitting a signal to the user-graphical interface, the signal containing data, which data can be manipulated and at least a portion of the data can be displayed to the user using the user-graphical interface.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. An automatic vapor generating machine for leak size estimation in a fluid system of a vehicle, comprising:
a housing;
a vapor generating chamber having a liquid reservoir for holding a supply of liquid and a heating element disposed within the chamber for vaporizing the liquid;
a gas inlet for connection to a source of pressurized gas;
an electrically controllable valve controllably connecting the gas inlet to the vapor generation chamber;
an outlet conduit in fluid communication with the chamber and configured to convey one of a vapor or a gas from the chamber;
an at least one of a flow sensor and a pressure sensor in fluid connection with the chamber for measuring at least one of a flow measurements and a pressure in the chamber and generating at least one electronic signal to a controller;
a heating switch for controlling the heating element;
a display mounted to the housing;
the controller connected to the electrically controllable valve, the at least one of the flow sensor and the pressure sensor, the heating switch and the display,
the controller having a memory and a data processor, the processor being able to execute instructions stored in the memory for:
receiving an operator command to perform a leak test;
opening the electrically controllable valve to cause one of the vapor or the gas to flow through the outlet conduit to attempt to pressurize the fluid system of the vehicle connected to the outlet conduit;
closing the electrically controllable valve after a predetermined period of time;
recording in the memory a series of values of the electronic signal over a duration of the leak test;
generating a graphical representation of the series of values of the electronic signal over the duration of the leak test and present the graphical representation on the display,
the graphical representation illustrating at least one of the flow measurements over time estimating a leak flow rate and the pressure in the chamber over time showing a leak dependent pressure decay over time.

2. The automatic vapor generating machine as defined in claim 1, further comprising a pressure regulator proximate the gas inlet for controlling the pressure in the chamber, the pressure regulator being connected to the controller and being controllable by the controller.

3. The automatic vapor generating machine as defined in claim 1, wherein the controller is configured to estimate a leak size over the duration of the leak test.

4. The automatic vapor generating machine as defined in claim 1, wherein information about the leak size is displayed on one of the display and an LED leak size indicator positioned on the housing and connected to the controller, the LED leak size indicator including a set of LED lights configured to selectively indicate at least a first leak size and a second leak size.

5. The automatic vapor generating machine as defined in claim 1, wherein the controller further includes a wireless connection configured to transmit data to a secondary device via a wireless network.

6. The automatic vapor generating machine as defined in claim 1, further including and temperature sensor in the chamber, the temperature sensor being connected to the controller and configured to send a temperature measurement electric signal thereto.

7. The automatic vapor generating machine as defined in claim 6, wherein the controller is configured to store and analyze historical data received from any one of the flow sensor, the pressure sensor and the temperature sensor, and the controller is configured to generate at least one graphical representation on the display, the at least one graphical representation being indicative of one of a time of occurrence of a leak, a pressure difference registered by the machine as a result of the leak, a first data for calculating pressure average, a second data for calculating flow measurement average, a third data for comparing tests, and an indication to run additional tests.

8. The automatic vapor generating machine as defined in claim 1, wherein the controller is configured to receive at least an input selection of one of a language of operation, an operating pressure in psi, Bar or KPa, a manual mode of operation, an automatic mode of operation, a test time, a vapor output, an air output, an alternating vapor and air output, a multiple operating program mode, and the display is configured to display at least an information related to any one of the language of operation, the operating pressure in psi, Bar or KPa, the manual mode of operation, the automatic mode of operation, the test time, the vapor output, the air output, the alternating vapor and air output, the multiple operating program mode.

9. The automatic vapor generating machine as defined in claim 1, wherein the controller is configured to provide one of an audio and a visual indication of one of a low fuel, machine overheating, leak occurrence, pressure drop, and a machine mal-functionality.

10. The automatic vapor generating machine as defined in claim 1, further comprising the processor being able to execute instructions stored in the memory for operating the heating switch to cause the heating element to heat the liquid thereby generating the vapor in the chamber for performing the leak test with vapor.

11. The automatic vapor generating machine as defined in claim 1, further comprising the processor being able to execute instructions stored in the memory for processing a series of values of the electronic signal over the duration of the leak test to calculate at least one of a time of occurrence of a leak, a pressure difference registered by the machine as a result of the leak, a pressure average over the duration of the leak test, a flow measurement average over the duration of the leak test, a pressure decay as a function of time over the duration of the leak test, changes in flow over time over the duration of the leak test, and a comparison of one of results and measurements of at least two leak tests.

12. The automatic vapor generating machine as defined in claim 1, wherein the at least one of a flow sensor and a pressure sensor proximate to one of the gas inlet and the outlet conduit.

13. An automatic vapor generating machine for leak size estimation in a fluid system of a vehicle comprising:
a housing;
a vapor generating chamber having a liquid reservoir for holding a supply of liquid and a heating element disposed within the chamber for vaporizing the liquid;
a gas inlet for connection to the source of pressurized gas;
an electrically controllable valve controllably connecting the gas inlet to the vapor generation chamber;
an outlet conduit in fluid communication with the chamber and configured to convey one of a vapor or a gas from the chamber;
an at least one of a flow sensor and a pressure sensor in fluid connection with the chamber for measuring at least one of a flow measurements and a pressure in the chamber and generating at least one electronic signal to a controller;
a heating switch for controlling the heating element;
a display mounted to the housing;
the controller connected to the electrically controllable valve, the at least one of the flow sensor and the pressure sensor, the heating switch and to the display,
the controller having a memory and a data processor, the processor being able to execute at least two leak test programs stored in the memory for controlling the machine,
the at least two leak test programs executing commands to:
perform at least three pressure tests, each pressure test including opening and closing the electrically controllable valve to provide a gas flow to pressurize the chamber and the fluid system to a predetermined pressure at least once during test,
receive and analyze the at least one electronic signal to estimate a leak size of the fluid system of the vehicle during each test,
the at least two leak test programs including at least one of a vapor test and a gas test, wherein during the vapor test the controller actuating the heating element and the machine generating vapor, and wherein during the gas test the machine pressurizing the chamber and the fluid system of a vehicle with gas from the source of the pressurized gas,
the at least two leak test programs of the controller being manually actuated,
the display being configured to display a selection of the at least two programs, initial parameters for any one of the at least two leak test programs, one of a real-time processed data from any one of the flow sensor and the pressure sensor, and a historical processed data from any one of the flow sensor and the pressure sensor,
data displayed on the display upon operating one of the at least two leak test programs providing an estimation of the leak size.

14. The automatic vapor generating machine as defined in claim 13, further comprising a pressure regulator proximate the gas inlet for controlling the pressure in the chamber, the pressure regulator being connected to the controller and being controllable by the controller.

15. The automatic vapor generating machine as defined in claim 13, wherein the controller is configured to calculate one of a pressure average, a flow average, a pressure decay function and a differential pressure decay.

16. The automatic vapor generating machine as defined in claim 13, further comprising an LED leak size indicator positioned on the housing and operationally connected to the controller, the LED leak size indicator being a set of LED lights configured to selectively indicate one of a first leak size and a second leak size.

17. The automatic vapor generating machine as defined in claim 13, wherein the predetermined pressure of any one of the at least two leak test programs is within a range of 0.5 to 2.5 psi or is within a range of 5 to 15 psi.

18. An automatic vapor generating machine as defined in claim 13, wherein the display is an LCD screen.

19. The automatic vapor generating machine as defined in claim 13, further comprising a temperature sensor within the chamber, the temperature sensor being connected to the controller and configured to send temperature measurement electric signals to the controller.

20. (canceled)

21. (canceled)

22. (canceled)

23. (canceled)

24. (canceled)

25. A method for leak size estimation in a fluid system of a vehicle using an automatic vapor generating machine connected to a source of pressurized gas, the method comprising:
filling a liquid reservoir for holding a supply of liquid with a vapor generating liquid, powering on the vapor generating machine,
selecting a leak test program from a selection on a display mounted on the housing of the vapor generating machine by manually commanding a controller,
setting a test pressure for the test program of the vapor generating machine manually commanding the controller,
setting a test time manually commanding the controller,
having the controller run the leak test program with selected test pressure and test time,
reading results of the leak test on the display, the results including a graphical representation of a pressure decay,
observing one of a pressure drop indicated in the graphical representation and a flow measurement of one of a gas or vapor flowing from the chamber into the fluid system of the vehicle,
determining at least one of a leak size in the fluid system of the vehicle, a time of occurrence of a leak, a pressure difference registered by the machine as a result of the leak, a first data for calculating a pressure average, a second data for calculating flow measurement average, an indication to run additional tests.
